(19) United States
(12) Patent Application Publication
(10) Pub. No.: US 2006/0187904 A1
(43) Pub. Date: Aug. 24, 2006

(54) VoIP gateway apparatus

(76) Inventor: Makoto Oouchi, Fukushima (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/217,298

(22) Filed: Sep. 2, 2005

(30) Foreign Application Priority Data
Feb. 21, 2005 (JP) 2005-43657

(51) Int. Cl. H04L 12/66; H04L 12/56

(52) U.S. Cl. 370/352; 370/401

(57) ABSTRACT

In order to make an IP telephone service available simply by connecting a PBX, for example, connected to a PSTN interface to IP telephone network without changing the numbering plan of the PBX if a call arrives at a line IF portion 101, an SIP processing portion 104 refers to a number storage portion 105, identifies the VoIP number corresponding to the PSTN number given to the call as the calling party number, converts the calling party number of the call to the identified VoIP number, and transmits the call through an IP network IF portion 102. Furthermore, if a call arrives at the IP network IF portion 102, the SIP processing portion 104 refers to the number storage portion 105, identifies the PSTN number corresponding to the VoIP number, which is the called party number of the call, converts the called party number of the call to the identified PSTN number, and transmits the call through the line IF portion 101.

### BACKGROUND OF THE INVENTION

The present invention relates to a VoIP (Voice over Internet Protocol) gateway apparatus which relays a call between a PSTN (Public Switched Telephone Network) interface and a VoIP network interface and, in particular, to a technology for connecting a PBX (Private Branch Exchange) to a VoIP network without editing a numbering plan defined in the PBX from a PSTN numbering system to a VoIP numbering system.

A VoIP gateway apparatus has been known as an apparatus which connects an existing PBX or telephone terminal to a VoIP network to receive an IP (Internet Protocol) telephone service. The VoIP gateway apparatus receives a call signal and/or control signal from the existing PBX or telephone terminal through a PSTN interface and may VoIP packetize and transmit them from a VoIP network interface to a VoIP network or may reproduce a call signal and/or control signal from a VoIP packet received from the VoIP network through the VoIP network interface and transmit them to the PBX or telephone terminal through the PSTN interface (see Laid-Open Publication No. 2003-298660 of unexamined Japanese application (hereinafter, referred to as Patent Document 1), for example).

### DISCLOSURE OF THE INVENTION

Problems to be Solved by the Invention

In order to receive an IP telephone service by connecting the PBX to a VoIP network through a VoIP gateway apparatus, instead of connecting the PBX to a PSTN from which the BPX has received a telephone service, the numbering system registered in a PBX must be changed since the contract number is changed.

The invention was made in view of the problem, and it is an object of the invention to make an IP telephone service available by connecting an accommodated device such as a PBX to a VoIP network without changing the numbering plan of the accommodated device connecting to a PSTN interface.

Means for Solving the Problems

In order to achieve the object, a VoIP gateway apparatus performs number editing in the present invention. More specifically, a VoIP gateway apparatus performs conversion from a PSTN number, which is a telephone number in a PSTN numbering system, to a VoIP number, which is a telephone number in a VoIP numbering system or conversion from the VoIP number to the PSTN number.

For example, a first aspect of the invention is a VoIP gateway apparatus which relays a call between a PSTN interface and a VoIP network interface, the apparatus including:

a storage unit which stores a correspondence between a PSTN number, which is a telephone number in a PSTN numbering system, and a VoIP number, which is a telephone number in a VoIP numbering system; and

a calling control unit which, if a call arrives at the PSTN interface, converts the PSTN number given to the calling party number of the call to a VoIP number stored in the storage unit corresponding to the PSTN number and transmits the call through the VoIP network interface.

A second aspect of the invention is a VoIP gateway apparatus which relays a call between a PSTN interface and a VoIP network interface, the apparatus including:

a storage unit which stores a correspondence between a PSTN number, which is a telephone number in a PSTN numbering system, and a VoIP number, which is a telephone number in a VoIP numbering system; and

a call-receiving control unit which, if a call arrives at the VoIP interface, identifies a PSTN number stored in the storage unit corresponding to the VoIP number, which is the called party number of the call, converts the identified PSTN number to the called party number of the call, and transmits the call through the PSTN interface.

### EFFECT OF THE INVENTION

According to the invention, a VoIP gateway apparatus performs number editing. When a call arriving at a PSTN interface has a PSTN number as a calling party number, the number is converted to a VoIP number and then transmitted to a VoIP network. Alternatively, the VoIP number given to the call arriving at a VoIP interface as a called party number may be converted to a PSTN number, and the call may be output from the PSTN interface. Thus, an IP telephone service can be made available by connecting an accommodated device such as a PBX connected to the PSTN interface to the VoIP network without changing the numbering plan defined in the accommodated device.

### BRIEF DESCRIPTION OF THE DRAWINGS

FIG. 1 is a schematic diagram of a VoIP gateway apparatus to which an embodiment of the present invention is applied;

FIG. 2 is a diagram schematically showing a number editing table;

FIG. 3 is a diagram showing a hardware configuration example of a VoIP gateway apparatus 1;

FIG. 4 is a flowchart for explaining call control processing by the VoIP gateway apparatus 1;

FIG. 5 is a flowchart for explaining calling control processing (S104 in FIG. 4);

FIG. 6 is a flowchart for explaining call-receiving control processing (S105 in FIG. 4);

FIG. 7 is a diagram showing a first application of the VoIP gateway apparatus 1 to a VoIP communication system;

FIG. 8 is a diagram showing a second application of the VoIP gateway apparatus 1 to the VoIP communication system;

FIG. 9 is a diagram showing a third application of the VoIP gateway apparatus 1 to the VoIP communication system; and

FIG. 10 is a diagram showing a fourth application of the VoIP gateway apparatus 1 to the VoIP communication system.

### BEST MODE FOR CARRYING OUT THE INVENTION

An embodiment of the present invention will be described below.

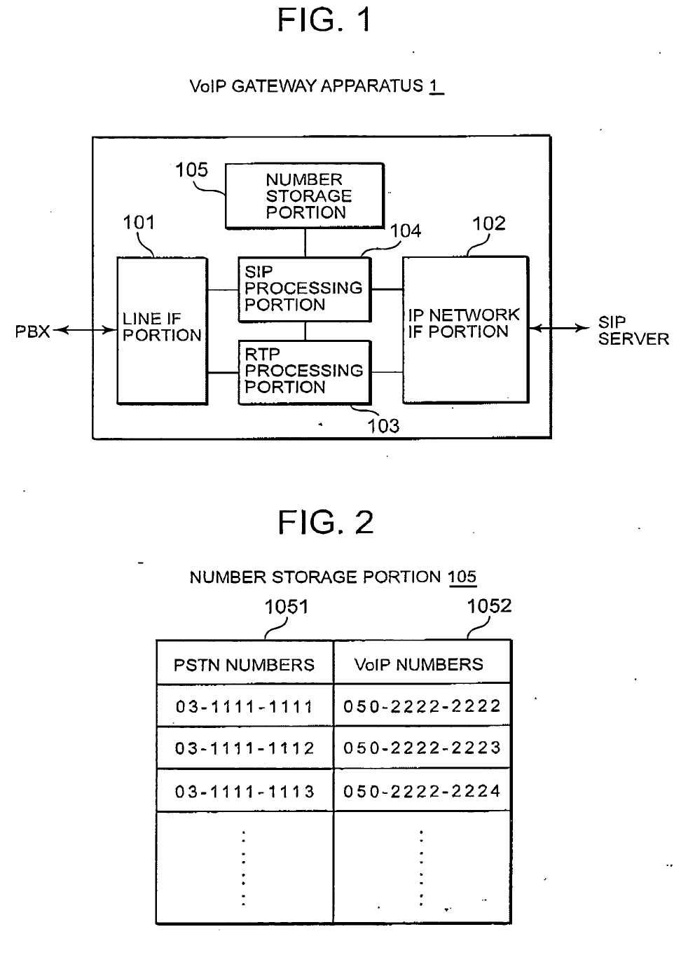

FIG. 1 is a schematic diagram of a VoIP gateway apparatus to which an embodiment of the invention is applied.

As shown in FIG. 1, a VoIP gateway apparatus 1 according to the embodiment includes a line IF (interface) portion 101, an IP network IF portion 102, an RTP (Real-time Transport Protocol) processing portion 103, an SIP (Session Initiation Protocol) processing portion 104, and a number storage portion 105.

The line IF portion 101 exchanges a call signal and a call control signal with an accommodated device such as a PBX through an ISDN (Integrated Services Digital Network) primary rate interface line, for example.

The IP network IF portion 102 exchanges a VoIP packet with a VoIP network over the Ethernet (registered trademark), for example.

The SIP processing portion 104 performs VoIP call control steps provided in SIP in liaison with an SIP server and establishes a call with a VoIP terminal of the other party. Then, the SIP processing portion 104 determines a channel (ISDN B-channel for example), which is to be allocated to the call for calling with an accommodated device and notifies the determined channel and the IP address of the VoIP terminal of the other party to the RTP processing portion 103. The SIP processing portion 104 further edits the calling party number of a call arriving at the line IF portion 101 (where the accommodated device is the caller) and the called party number of the call arriving at the IP network IF portion 102 (where the accommodated device is the receiver).

The RTP processing portion 103 performs processing provided in RTP on the call signal that the line IF portion 101 has received from the accommodated device via the channel notified by the SIP processing portion 104 and on the RTP packet of a VoIP terminal that the IP network IF portion 102 has received and has the IP address notified by the SIP processing portion 104.

More specifically, the RTP processing portion 103 RTP-packetizes the call signal that the line IF portion 101 has received via the channel notified by the SIP processing portion 104 and transmits the RTP packet to the IP network IF portion 102 by using the IP address notified by the SIP processing portion 104 as the address. Furthermore, the call number is reproduced from the RTP packet that the IP network IF portion 102 has received and is received from the IP address notified by the SIP processing portion 104 and is transmitted to the channel notified by the SIP processing portion 104 through the line IF portion 101.

The number storage portion 105 stores a number editing table to be used by the SIP processing portion 104 for number editing. FIG. 2 is a diagram schematically showing the number editing table. As shown in FIG. 2, the calling party number editing table has a correspondence between a PSTN number 1051, which is a telephone number in a PSTN numbering system, and a VoIP number 1052, which is a telephone number in an IP telephone network. In addition, the IP telephone network is an IF network which supplies telephone communication service in VoIP. Here, the PSTN number 1051 may be a number including a joint of an outside number and an extension number.

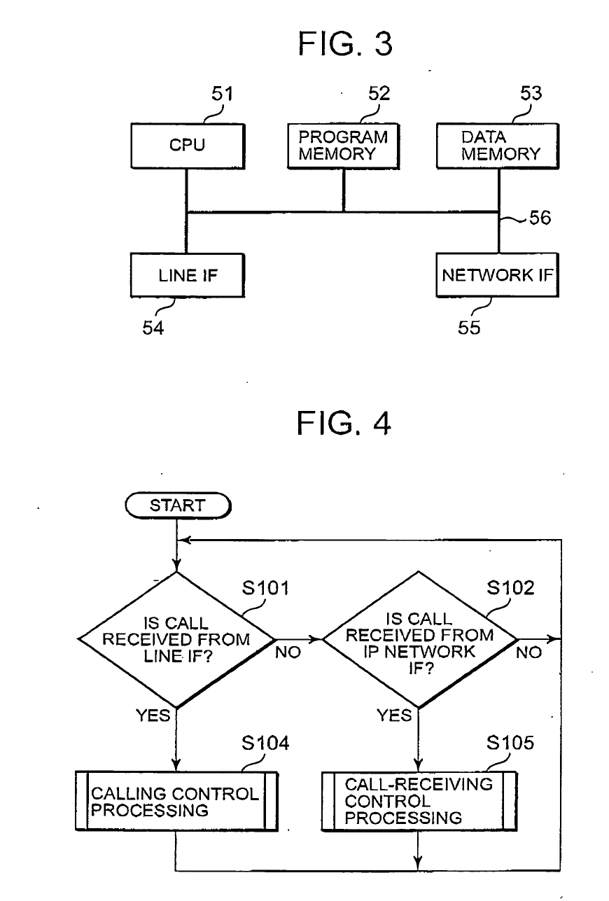

The VoIP gateway apparatus 1 as explained above is implemented by executing, by a CPU 51, a program stored in a program memory 52 in a computer system including, as shown in FIG. 3, for example, the CPU 51, the program memory 52 storing the program, a data memory 53 storing data, an line IF 54 which connects to the ISDN primary rate interface line, for example, and communicates with an accommodated device through the Line, a network IF 55 which connects to a LAN cable, for example, and communicates with a VoIP network via the cable and an internal bus 56 which mutually connects the components 51 to 55. In this case, the number storage portion 105 may be the data memory 53. The line IF portion 101 may be the line IF 54. The IP network IF portion 102 may be the network IF 55.

Next, an operation of the VoIP gateway apparatus 1 in this configuration will be described.

FIG. 4 is a flowchart for explaining call control processing by the VoIP gateway apparatus 1.

When the line IF portion 101 receives a SETUP message via an ISDN D-channel, for example (where the accommodated device is the caller) (Yes in S101), the SIP processing portion 104 performs calling processing (S104), which will be described later. When the IP network IF portion 102 receives an SIP packet storing an INVITE message (where the accommodated device is the receiver) (No in S101 and Yes in S102), the SIP processing portion performs call-receiving control processing (S105), which will be described later. In this way, the call originating state is continuously being monitored.

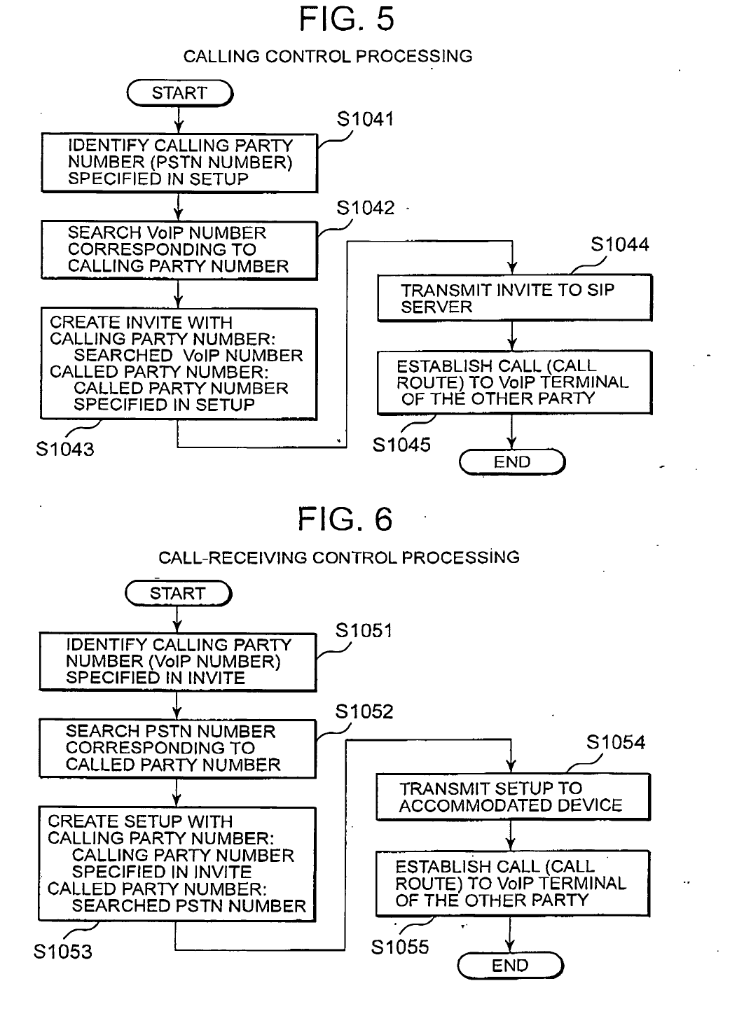

FIG. 5 is a flowchart for explaining calling control processing (S104 in FIG. 4).

The SIP processing portion 104 identifies the calling party number (or calling party number and subaddress of the calling party number) included in the SETUP message that the line IF portion 101 has received (S1041). Next, the SIP processing portion 104 refers to the number storing portion 105, searches the identified calling party number (or a joint number of the calling party number and subaddress of the calling party number) from PSTN numbers 1051 stored in the number storage portion 105 and identifies the VoIP number 1052 corresponding to the PSTN number 1051 agreeing with the calling party number (S1042). Then, the SIP processing portion 104 creates an SIP packet storing an INVITE message having the identified VoIP number as the calling party number and the called party number (VoIP number) included in the SETUP message as the called party number (S1043) and transmits the SIP packet to the VoIP network through the IP network IF portion 102 (S1044). The INVITE message is transferred to the VoIP terminal of the other party through the SIP server. Then, the VoIP terminal of the other party transmits a response message (200OK) to the VoIP gateway apparatus 1. After that, the SIP processing portion 104 performs SIP-based call control steps with respect to the VoIP terminal that has transmitted the response message and establishes the call to the VoIP terminal (S1045).

Then, the SIP processing portion 104 requests the line IF portion 101 for channel allocation. In response thereto, the line IF portion 101 defines a channel to the accommodated device to which the established call is allocated and notifies the defined channel to the SIP processing portion 104. The SIP processing portion 104 notifies the RTP processing portion 103 of the channel notified from the line IF portion 101 and the IP address of the VoIP terminal of the other party. In response thereto, the RTP processing portion 103 performs processing provided in RTP on the call signal that the line IF portion 101 has received from the accommodated device via the channel notified by the SIP processing portion 104 and on the RTP packet of the other party that the IP network IF portion 102 has received and has the IP address notified by the SIP processing portion 104. Thus, the call is enabled.

FIG. 6 is a flowchart for explaining the call-receiving processing (S105 in FIG. 4).

The SIP processing portion 104 identifies the called party number included in the INVITE message that the IP network IF portion 102 has received (S1051). Next, the SIP processing portion 104 refers to the number storing portion 105, searches the identified called party number from VoIP numbers 1052 stored in the number storage portion 105 and identifies the PSTN number 1051 corresponding to the VoIP number 1052 agreeing with the calling party number (S1052). Then, the SIP processing portion 104 creates a SETUP message having the identified PSTN number as the called party number (the outside number as the called party number and the extension line number as the subaddress of the called party number if the identified PSTN number is a joint number of the outside number and the extension number) and the calling party number (VoIP number) included in the INVITE message as the calling party number (S1053) and transmits the SETUP message from the line IF portion 101 to the accommodated device via the ISDN D-channel, for example (S1054). Then, the accommodated device transmits a response message (CONNECT) to the VoIP gateway apparatus 1. After that, the SIP processing portion 104 performs SIP-based call control steps with respect to the VoIP terminal that has transmitted the INVITE and establishes the call to the VoIP terminal (S1055).

Then, the SIP processing portion 104 requests the line IF portion 101 for channel allocation. In response thereto, the line IF portion 101 defines a channel to the accommodated device to which the established call is allocated and notifies the defined channel to the SIP processing portion 104. The SIP processing portion 104 notifies the RTP processing portion 103 of the channel notified from the line IF portion 101 and the IP address of the VoIP terminal of the other party. In response thereto, the RTP processing portion 103 performs processing provided in RTP on the call signal that the line IF portion 101 has received from the accommodated device via the channel notified by the SIP processing portion 104 and on the RTP packet of the other party that the IP network IF portion 102 has received and has the IP address notified by the SIP processing portion 104. Thus, the call is enabled.

Next, applications of the VoIP gateway apparatus 1 in this construction to a VoIP communication system will be described.

First Application

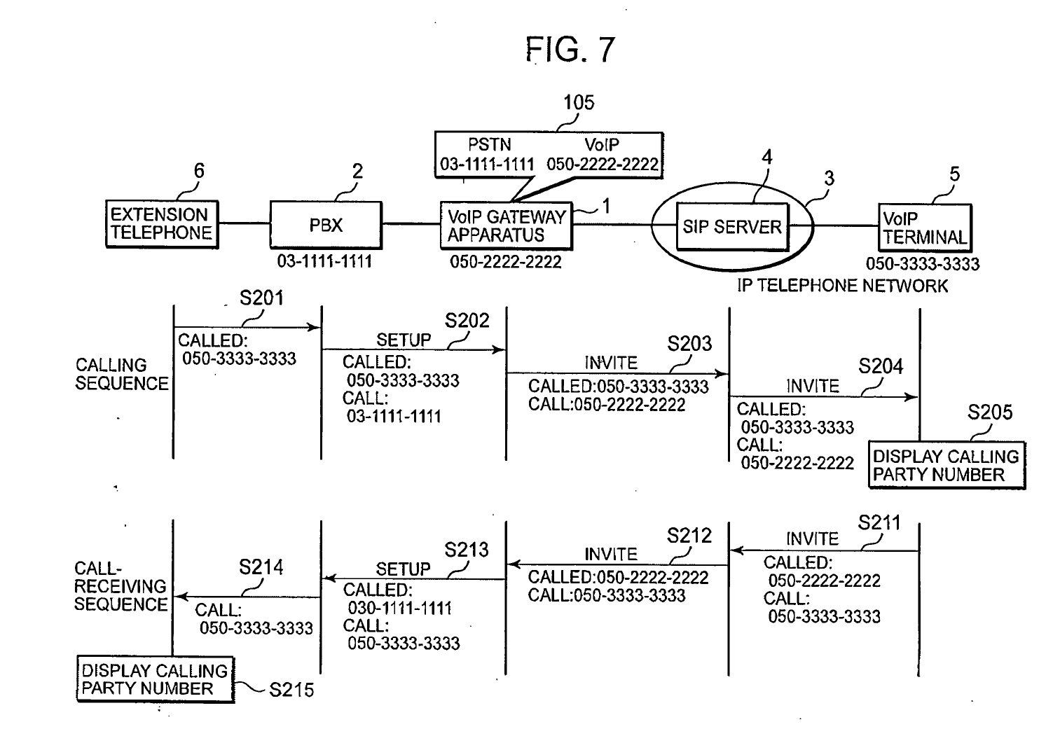

FIG. 7 is a diagram showing a first application of the VoIP gateway apparatus 1 to a VoIP communication system. Here, the VoIP gateway apparatus 1 is connected to a PBX 2 via an ISDN cable and is connected to an IP telephone network 3(an IP network which supplies telephone communication service in VoIP) including an SIP server 4 via an Ethernet (registered trademark) cable. A VoIP terminal 5 is connected to the IP telephone network 3. An extension telephone 6 is connected to the PBX 2.

In calling, the PBX 2 outputs a call (SETUP message) having a contract number registered therein as a calling party number. The VoIP terminal 5 has a caller number display function of displaying a calling party number given to the call (INVITE message) on a display portion in receiving a call. The extension telephone 6 also has a caller number display function of displaying a calling party number notified from the PBX 2 on a display portion in receiving a call. Then, the number storage portion 105 of the VoIP gateway apparatus 1 has a contract number of an ISDN telephone service to which a user of the PBX 2 subscribes as the PSTN number 1051 and a contract number of a VoIP IP telephone service to which the user of the PBX 2 subscribes as the VoIP number 1052.

Here, the contract number, “03-1111-1111”, of an ISDN telephone service to which the user of the PBX 2 subscribes has been registered with the PBX 2. The contract number of a VoIP IP telephone service to which the user of the PBX 2 subscribes is “050-2222-2222”, and the contract number of the VoIP IP telephone service to which a user of the VoIP terminal 5 subscribes is “050-3333-3333”.

1. Calling Sequence

In the environment as described above, when the extension telephone 6 is starting state (off-hook) and the telephone number, “050-3333-3333”, of the VoIP terminal 5 is input thereto (S201), the PBX 2 transmits to the VoIP gateway apparatus 1 a SETUP message having the contract number “03-1111-1111”, which is defined in the PBX 2, as the calling party number and having the telephone number, “050-3333-3333”, of the VoIP terminal 5 as the called party number (S202).

Upon receipt of the SETUP message from the PBX 2, the VoIP gateway apparatus 1 searches the PSTN number agreeing with the calling party number, “03-1111-1111”, given to the SETUP message through the number storage portion 105 and identifies the VoIP number, “050-2222-2222”, corresponding to the searched PSTN number, “03-1111-1111”. Then, the VoIP gateway apparatus 1 transmits to the SIP server 4 an INVITE message having the identified VoIP number, “050-2222-2222”, as the calling party number and having the telephone number, “050-3333-3333” of the VoIP terminal 5 as the called party number (S203).

The SIP server 4 locates the position (IP address) of the VoIP terminal 5 from the called party number, “050-3333-3333”, specified in the INVITE message received from the VoIP gateway apparatus 1 and transfers the INVITE message to the VoIP terminal 5 (S204). Then, upon receipt of the INVITE message from the SIP server 4, the VoIP terminal 5 displays the calling party number, “050-2222-2222” specified in the INVITE message (S205). After that, the SIP-based call control steps are performed in liaison with each of the devices, thereby a call route between the VoIP terminal 5 and the extension terminal 6 is formed.

1. Call-Receiving Sequence

In the environment as described above, when the VoIP terminal 5 is off-hook and the telephone number (IP telephone service contract number), “050-2222-2222”, of the PBX 2 is input thereto, the VoIP terminal 5 transmits to the SIP server 4 an INVITE message having the contract number “050-3333-3333”, which is defined in the VoIP terminal 5, as the calling party number and having the telephone number, “050-2222-2222”, of the PBX 2 as the called party number (S211).

The SIP server 4 locates the position (IP address) of the VoIP gateway apparatus 1 to which the PBX 2 is connected from the called party number, “050-2222-2222”, specified in the INVITE message received from the VoIP terminal 5 and transfers the INVITE message to the VoIP gateway apparatus 1 (S212).

Upon receipt of the INVITE message from the SIP server 4, the VoIP gateway apparatus 1 searches the VoIP number agreeing with the called party number, “050-2222-2222”, specified in the INVITE message through the number storage portion 105 and identities the PSTN number, “03-1111-1111”, corresponding to the searched VoIP number, “050-2222-2222”. Then, the VoIP gateway apparatus 1 transmits to the PBX 2 a SETUP message having the identified PSTN number, “03-1111-1111” as the called party number and having the telephone number, “050-3333-3333” of the VoIP terminal 5 as the calling party number (S213).

Upon receipt of the SETUP message from the VoIP gateway apparatus 1, the PBX 2 notifies the extension telephone 6 of the calling party number, “050-3333-3333”, specified in the SETUP message and invokes the extension telephone 6 (S214). In response thereto, the extension telephone 6 displays the calling party number, “050-3333-3333” notified by the PBX 2 (S215). After that, the SIP-based call control steps are performed in liaison with each of the devices, thereby a call route between the VoIP terminal 5 and the extension terminal 6 is formed.

Second Application

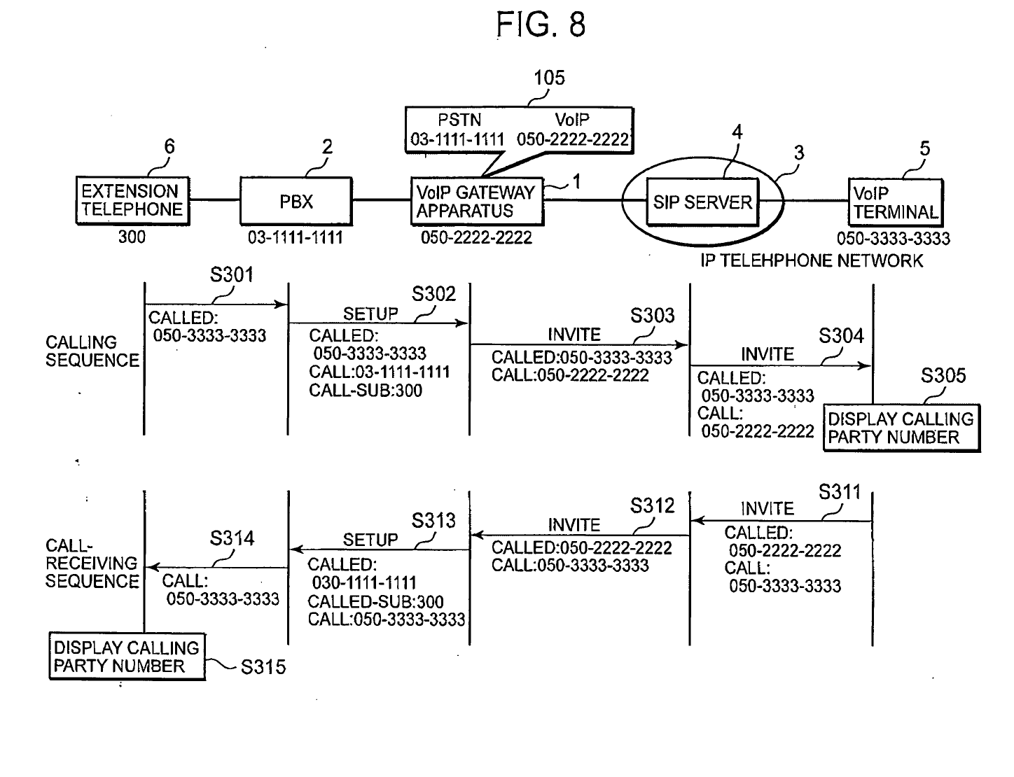

FIG. 8 is a diagram showing a second application of the VoIP gateway apparatus 1 to a VoIP communication system. The VoIP communication system is basically the same as the VoIP communication system for the first application in FIG. 7 except for the following points.

That is, in calling, the PBX 2 outputs a call (SETUP message) having a contract number registered therein as a calling party number and having the extension number given to the off-hook extension terminal 6 as a subaddress of the calling party number. The number storage portion 105 of the VoIP gateway apparatus 1 has a contract number of an ISDN telephone service to which a user of the PBX 2 subscribes and the extension number of the extension telephone 6 connecting to the PBX 2 as the PSTN number 1051 and a contract number of a VoIP IP telephone service to which a user of the PBX 2 subscribes as the VoIP number 1052.

Here, the contract number “03-1111-1111” of an ISDN telephone service to which the user of the PBX 2 subscribes and the extension number, “300”, of the extension telephone 6 have been registered with the PBX 2. The contract number of a VoIP IP telephone service to which the user of the PBX 2 subscribes is “050-2222-2222”, and the contract number of the VoIP IP telephone service to which a user of the VoIP terminal 5 subscribes is “050-3333-3333”.

1. Calling Sequence

In the environment as described above, when the extension telephone 6 is off-hook and the telephone number, “050-3333-3333”, of the VoIP terminal 5 is input thereto (S301), the PBX 2 transmits to the VoIP gateway apparatus 1 a SETUP message having the contract number (Sbscriber's Number), “03-1111-1111”, which is defined in the PBX 2, as the calling party number and the extension number, “300”, of the off-hook extension telephone 6 as the subaddress of the calling-party number and having the telephone number, “050-3333-3333”, of the VoIP terminal 5 as the called party number (S302).

Upon receipt of the SETUP message from the PBX 2, the VoIP gateway apparatus 1 searches the PSTN number agreeing with the joint number of the calling party number, “03-1111-1111”, given to the SETUP message and the subaddress, “300”, of the calling party number given to the SETUP message through the number storage portion 105 and identifies the VoIP number, “050-2222-2222”, corresponding to the searched PSTN number, “03-1111-1111-300”. Then, the VoIP gateway apparatus 1 transmits to the SIP server 4 an INVITE message having the identified VoIP number, “050-2222-2222, as the calling party number and having the telephone number, “050-3333-3333” of the VoIP terminal 5 as the called party number (S303).

The SIP server 4 locates the position (IP address) of the VoIP terminal 5 from the called party number, “050-3333-3333”, specified in the INVITE message received from the VoIP gateway apparatus 1 and transfers the INVITE message to the VoIP terminal 5 (S304). Then, upon receipt of the INVITE message from the SIP server 4, the VoIP terminal 5 displays the calling party number, “050-2222-2222”, specified in the INVITE message (S305). After that, the SIP-based call control steps are performed in liaison with each of the devices, thereby a call route between the VoIP terminal 5 and the extension terminal 6 is formed.

2. Call-Receiving Sequence

In the environment as described above, when VoIP terminal 5 is off-hook and the telephone number (IP telephone service contract number), “050-2222-2222” of the PBX 2 is input thereto, the VoIP terminal 5 transmits to the SIP server 4 an INVITE message having the contract number, “050-3333-3333”, which is defined in the VoIP terminal 5, as the calling party number and having the telephone number, “050-2222-2222”, of the PBX 2 as the called party number (S311).

The SIP server 4 locates the position (IP address) of the VoIP gateway apparatus 1 to which the PBX 2 is connected from the called party number, “050-2222-2222”, specified in the INVITE message received from the VoIP terminal 5 and transfers the INVITE message to the VoIP gateway apparatus 1 (S312).

Upon receipt of the INVITE message from the SIP server 4, the VoIP gateway apparatus 1 searches the VoIP number agreeing with the called party number, “050-2222-2222”, specified in the INVITE message through the number storage portion 105 and identifies the PSTN number, “03-1111-1111-300”, corresponding to the searched VoIP number, “050-2222-2222” and separates the extension number, “300”, from the identified PSTN number. Then, the VoIP gateway apparatus 1 transmits to the PBX 2 a SETUP message having the PSTN number, “03-1111-1111”, remaining after the extension number, “300” is separated therefrom as the called party number and the separated extension number, “300”, as the subaddress of the called party number and having the telephone number, “050-3333-3333”, of the VoIP terminal 5 as the calling party number (S313).

Upon receipt of the SETUP message from the VoIP gateway apparatus 1, the PBX 2 notifies the extension telephone 6 of the calling party number, “050-3333-3333”, specified in the SETUP message and invokes the extension telephone 6 having the subaddress, ¢300”, of the called party number specified in the SETUP message as the extension number (S314). In response thereto, the extension telephone 6 with the extension number, “300”, displays the calling party number, “050-3333-3333” notified by the PBX 2 (S315). After that, the SIP-based call, control steps are performed in liaison with each of the devices, thereby a call route between the VoIP terminal 5 and the extension terminal 6 is formed.

Third Application

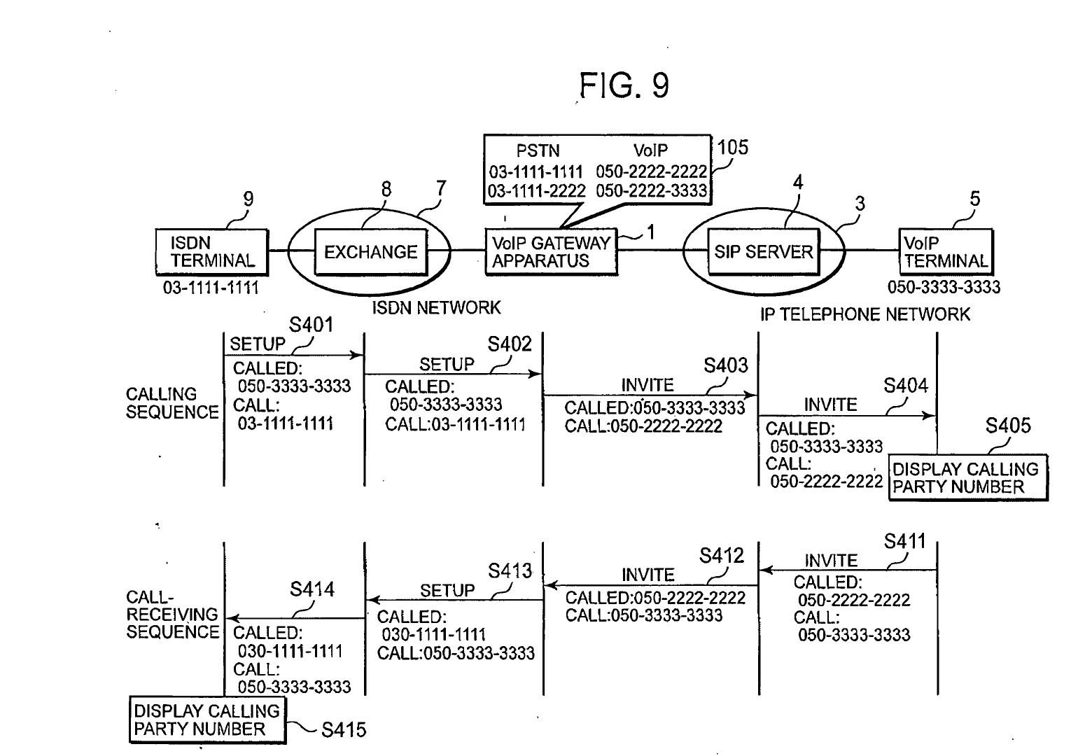

FIG. 9 is a diagram showing a third application of the VoIP gateway apparatus 1 to a VoIP communication system. Here, the VoIP gateway apparatus 1 is connected to an ISDN network 7 including an exchange 8 via an ISDN cable and is also connected to the IP telephone network 3 including the SIP server 4 via an Ethernet (registered trademark) cable. An ISDN terminal 9 is connected to the PSTN network 7, and the VoIP terminal 5 is connected to the IP telephone network 3.

In calling, the ISDN terminal 9 outputs a call (SETUP message) having a contract number registered therein as a calling party number. The ISDN terminal 9 further has a caller number display function of displaying a calling party number notified from the ISDN network 7 in receiving a call. The VoIP terminal 5 also has a caller number display function of displaying a calling party number given to a call (INVITE message) in receiving the call. Then, the number storage portion 105 of the VoIP gateway apparatus 1 has a contract number of an ISDN telephone service to which a user of the ISDN terminal 9 subscribes as the PSTN number 1051 and a contract number of a VoIP IP telephone service to which the user of the ISDN terminal 9 subscribes as the VoIP number 1052.

Here, the contract number “103-1111-1111” of an ISDN telephone service to which a user of the PBX 2 subscribes has been registered with the ISDN terminal 9. The contract number of a VoIP IS telephone service to which the user of the ISDN terminal 9 subscribes is “050-2222-2222”, and the contract number of a VoIP IP telephone service to which a user of the VoIP terminal 5 subscribes is “050-3333-3333”.

1. Calling Sequence

In the environment as described above, when the ISDN terminal 9 is off-hook and the telephone number (IP telephone service contract number), “050-3333-3333”, of the VoIP terminal 5 is input thereto, the ISDN terminal 9 transmits to the ISDN network 7 a SETUP message having the contract number “03-1111-1111”, which is defined in the ISDN terminal 9, as the calling party number and having the telephone number, “050-3333-3333”, of the VoIP terminal 5 as the called party number (S401). Then, the exchange 8 transfers to the VoIP gateway apparatus 1 the SETUP message transmitted from the ISDN terminal 9 based on the called party number, “050-3333-3333” specified in the SETUP message (S402).

Upon receipt of the SETUP message from the ISDN network 7, the VoIP gateway apparatus 1 searches the PSTN number agreeing with the calling party number, “03-1111-1111”, given to the SETUP message through the number storage portion 105 and identifies the VoIP number, “050-2222-2222”, corresponding to the searched PSTN number, “03-1111-1111”. Then, the VoIP gateway apparatus 1 transmits to the SIP server 4 an INVITE message having the identified VoIP number, “050-2222-2222”, as the calling party number and having the telephone number, “050-3333-3333”, of the VoIP terminal 5 as the called party number (S403)

The SIP server 4 locates the position (IP address) of the VoIP terminal 5 from the called party number, “050-3333-3333”, specified in the INVITE message received from the VoIP gateway apparatus 1 and transfers the INVITE message to the VoIP terminal 5 (S404). Then, upon receipt of the INVITE message from the SIP server 4, the VoIP terminal 5 displays the calling party number, “050-2222-2222”, specified in the INVITE message (S405). After that, the ISDN- and SIP-based call control steps are performed in liaison with each of the devices, thereby a call route between the ISDN terminal 9 and the VoIP terminal 5 is formed.

2. Call-Receiving Sequence

In the environment as described above, when VoIP terminal 5 is off-hook and the telephone number (IP telephone service contract number), “050-2222-2222”, of the ISDN terminal 9 is input thereto, the VoIP terminal 5 transmits to the SIP server 4 an INVITE message having the contract number “050-3333-3333”, which is defined in the VoIP terminal 5, as the calling party number and having the telephone number, “050-2222-2222”, of the ISDN terminal 9 as the called party number (S411).

The SIP server 4 locates the position (IP address) of the VoIP gateway apparatus 1 from the called party number, “050-2222-2222”, specified in the INVITE message received from the VoIP terminal 5 and transfers the INVITE message to the VoIP gateway apparatus 1 (S412).

Upon receipt of the INVITE message from the SIP server 4, the VoIP gateway apparatus 1 searches the VoIP number agreeing with the called party number, “050-2222-2222”, specified in the INVITE message through the number storage portion 105 and identifies the PSTN number, “03-1111-1111”, corresponding to the searched VoIP number, “050-2222-2222”. Then, the VoIP gateway apparatus 1 transmits to the ISDN network 7 a SETUP message having the identified PSTN number, “03-1111-1111”, as the called party number and the telephone number, “050-3333-3333” of the VoIP terminal 5 as a calling party number (S413). Then, the exchange 8 transfers to the ISDN terminal 9 the SETUP message transmitted from the VoIP gateway apparatus 1 based on the called party number, “03-1117-1111”, specified in the SETUP message (S414). Then, upon receipt of the SETUP message from the ISDN network 7, the ISDN terminal 9 displays the calling party number, “050-3333-3333”, specified in the SETUP message (S415). After that, the ISDN- and SIP-based call control steps are performed in liaison with each of the devices, thereby a call route between the ISDN terminal 9 and the VoIP terminal 5 is formed.

Fourth Application

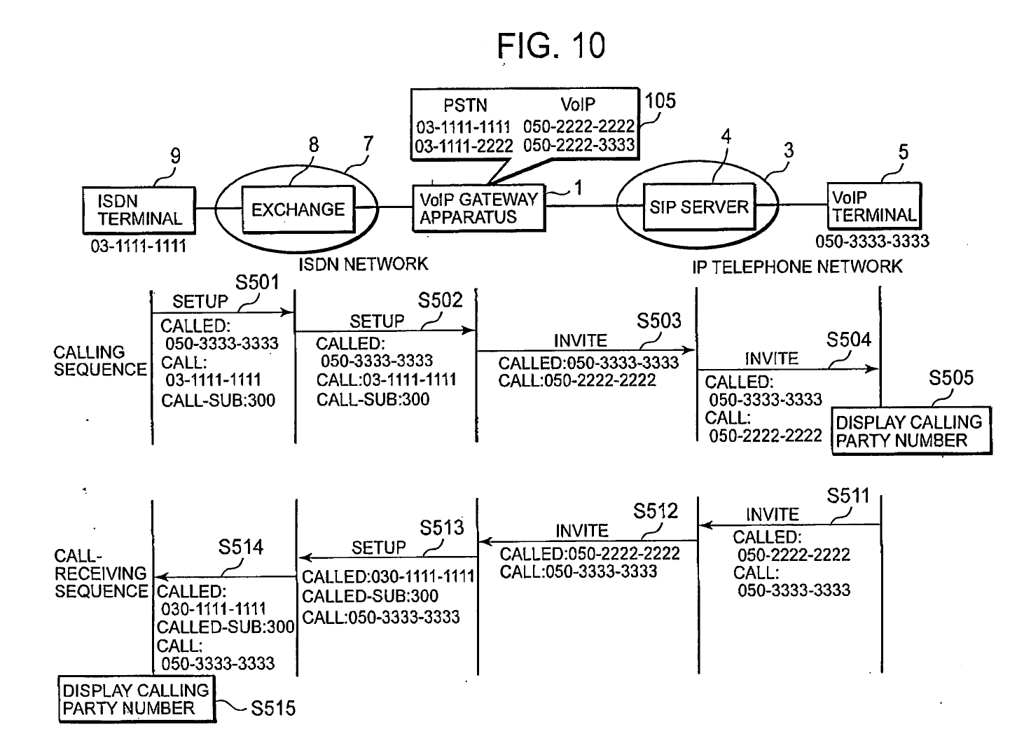

FIG. 10 is a diagram showing a fourth application of the VoIP gateway apparatus 1 to a VoIP communication system. The VoIP communication system is basically the same as the VoIP communication system for the third application in FIG. 9 except for the following points.

That is, the ISDN terminal 9 is a PBX, for example, and, in calling, outputs a call (SETUP message) having a contract number registered therein as a calling party number and having the extension number given to an extension telephone (not shown) accommodated in the ISDN terminal 9 as a subaddress of the calling party number. The number storage portion 105 of the VoIP gateway apparatus 1 has a contract number of an ISDN telephone service to which a user of the ISDN terminal 9 subscribes and the extension number of the extension telephone that the ISDN terminal 9 accommodates as the PSTN number 1051 and a VoIP IP telephone service contract number to which the user of the ISDN terminal 9 subscribes as the VoIP number 1052.

Here, the contract number, “03-1111-1111”, of an ISDN telephone service to which the user of the ISDN terminal 9 subscribes and the extension number, “300”, of the extension telephone that the ISDN terminal 9 accommodates have been registered with the ISDN terminal 9. The contract number of the VoIP IP telephone service to which the user of the ISDN terminal 9 subscribes is “050-2222-2222”, and the contract number of the VoIP IF telephone service to which the user of the VoIP terminal 5 subscribes is “050-3333-3333”.

1. Calling Sequence

In the environment as described above, when the extension telephone that the ISDN terminal 9 accommodates is off-hook and the telephone number (IF telephone service contract number), “050-3333-3333”, of the VoIP terminal 5 is input thereto, the ISDN terminal 9 transmits to the ISDN network 7 a SETUP message having the contract number, “03-1111-1111”, which is defined in the ISDN terminal 9, as the calling party number and the extension number, “300”, of the off-hook extension telephone as the subaddress of the calling-party number and having the telephone number, “050-3333-3333”, of the VoIP terminal 5 as the called party number (S501). Then, the exchange 8 transfers to the VoIP gateway apparatus 1 the SETUP message transmitted from the ISDN terminal 9 based on the called party number, “050-3333-3333”, specified in the SETUP message (S502).

Upon receipt of the SETUP message from the ISDN network 7, the VoIP gateway apparatus 1 searches the PSTN number agreeing with the joint number of the calling party number, “03-1111-1111”, given to the SETUP message and the subaddress, “300”, of the calling party number given to the SETUP message through the number storage portion 105 and identifies the VoIP number, “050-2222-2222”, corresponding to the searched PSTN number, “03-1111-1111-300”. Then, the VoIP gateway apparatus 1 transmits to the SIP server 4 an INVITE message having the identified VoIP number, “050-2222-2222”, as the calling party number and having the telephone number, “050-3333-3333”, of the VoIP terminal 5 as the called party number (S503).

The SIP server 4 locates the position (IP address) of the VoIP terminal 5 from the called party number, “050-3333-3333”, specified in the INVITE message received from the VoIP gateway apparatus 1 and transfers the INVITE message to the VoIP terminal 5 (S504). Then, upon receipt of the INVITE message from the SIP server 4, the VoIP terminal 5 displays the calling party number, “050-2222-2222” specified in the INVITE message (S505). After that, the ISDN- and SIP-based call control steps are performed in liaison with each of the devices, thereby a call route between the ISDN terminal 9 and the VoIP terminal 5 is formed.

2. Call-Receiving Sequence

In the environment as described above, when VoIP terminal 5 is off-hook and the telephone number (IP telephone service contract number), “1050-2222-2222”, of the ISDN terminal 9 is input thereto, the VoIP terminal 5 transmits to the SIP server 4 an INVITE message having the contract number, “050-3333-3333”, which is defined in the VoIP terminal 5, as the calling party number and having the telephone number, “050-2222-2222”, of the ISDN terminal 9 as the called party number (S511).

The SIP server 4 locates the position (IP address) of the VoIP gateway apparatus 1 from the called party number, “050-2222-2222”, specified in the INVITE message received from the VoIP terminal 5 and transfers the INVITE message to the VoIP gateway apparatus 1 (S512).

Upon receipt of the INVITE message from the SIP server 4, the VoIP gateway apparatus 1 searches the VoIP number agreeing with the called party number, “050-2222-2222”, specified in the INVITE message through the number storage portion 105 and identifies the PSTN number, “103-1111-1111-300”, corresponding to the searched VoIP number, “050-2222-2222” and separates the extension number, “300”, from the identified PSTN number. Then, the VoIP gateway apparatus 1 transmits to the ISDN network 7 a SETUP message having the PSTN number, “03-1111-1111”, remaining after the extension number, “300” is separated therefrom as the called party number and the separated extension number, “300”, as the subaddress of the called party number and having the telephone number, “050-3333-3333”, of the VoIP terminal 5 as the calling party number (S513). Then, the exchange 8 transfers to the ISDN terminal 9 the SETUP message transmitted from the VoIP gateway apparatus 1 based on the called party number, “03-1111-1111”, specified in the SETUP message (S514).

Upon receipt of the SETUP message from the VoIP gateway apparatus 1, the ISDN terminal 9 notifies the calling party number, “050-3333-3333”, specified in the SETUP message to and invokes the extension telephone having the subaddress, “300”, of the called party number specified in the SETUP message as the extension number. In response thereto, the extension telephone with the extension number, “300”, displays the calling party number, “050-3333-3333” notified by the ISDN terminal 9 (S515). After that, the SIP-based call control steps are performed in liaison with each of the devices, thereby a call route between the VoIP terminal 5 and the extension telephone is formed.

The embodiment of the present invention has been described up to this point.

According to the present invention, the VoIP gateway apparatus 1 performs number editing. When a call arriving at the line IF portion 101 has a PSTN number as a calling party number, the number is converted to a VoIP number and is then transmitted to IP telephone network. Alternatively, the VoIP number given to the call arriving at the IP network IF portion 102 as the called party number is converted to a PSTN number, and the call is then output through the line IF portion 101. Therefore, the IP telephone service can be made available to an accommodated device such as a PBX connecting to the line IF portion 101, by connecting the accommodated device to the VoIP network without changing the numbering plan of the accommodated device.

The present invention is not limited to the above-described embodiment, but many changes can be made thereto without departing from the spirit and scope thereof. For example, though, according to this embodiment, it is described that the VoIP gateway apparatus 1 performs number editing on both of the calling party number of the call arriving at the line IF portion 101 and the called party number of the call arriving at the IP network IF portion 102, the number editing may be performed only on one of them.

Having described the case that the line IF portion 101 is connected to an ISDN in this embodiment, for example, the present invention is not limited thereto. An accommodated device such as a PBX connecting to the line IF portion 101 may only need to give a calling party number to a call arriving at the line IF portion 101, and, in this case, an analog interface (such as 2Wire FXS interface, 4Wire SS/SR signaling system interface, etc.) may be adopted instead. Furthermore, in order to perform number editing only on the called party number of a call arriving at the IP network IF portion 102, the call arriving at the line IF portion 101 does not have to have the calling party number.

Having described the case that the VoIP gateway apparatus 1 uses the SIP server 4 in this embodiment, for example, the present invention is not limited thereto. The VoIP gateway apparatus 1 may have the function of the SIP server 4. Furthermore, having described the case that SIP is used as a call control protocol using a VoIP IF telephone service in this embodiment, for example, the invention is not limited thereto. For example, H.323 may be adopted instead.

Each of the above-described configurations in the VoIP gateway apparatus 1does not have to be implemented by executing a program by a computer. They may be implemented in hardware by an integrated logic IC such as an ASIC (Application Specific Integrated Circuit) and FPGA (Field Programmable Gate Array) or may be implemented in software by a computer such as a DSP (Digital Signal Processor).

What is claimed is:

1. A VoIP gateway apparatus which relays a call between a PSTN interface and an IP telephone network interface, the apparatus comprising:
storage means which stores a correspondence between a PSTN number, which is a telephone number in a PSTN numbering system, and a VoIP number, which is a telephone number in a VoIP numbering system; and
calling control means which, if a call arrives at the PSTN interface, converts the PSTN number given to the calling party number of the call to a VoIP number stored in the storage means corresponding to the PSTN number and transmits the call through the VoIP network interface.

2. The VoIP gateway apparatus according to claim 1, wherein;
the PSTN number is the joint number of a telephone number and subaddress for a PSTN telephone service; and
the calling control means, if a call arrives at the PSTN interface, handles the joint number of the calling party number specified in the call and the subaddress of the calling party number as a PSTN number given to the calling party number of the call.

3. A VoIP gateway apparatus which relays a call between a PSTN interface and an IP telephone network interface, the apparatus comprising;
storage means which stores a correspondence between a PSTN number, which is a telephone number in a PSTN numbering system, and a VoIP number, which is a telephone number in a VoIP numbering system; and
call-receiving control means which, if a call arrives at the VoIP interface, identifies a PSTN number stored in the storage means corresponding to the VoIP number, which is the called party number of the call, converts the identified PSTN number to the called party number of the call, and transmits the call through the PSTN interface.

4. A VoIP gateway apparatus which relays a call between a PSTN interface and an IP telephone network interface, the apparatus comprising:
storage means which stores a correspondence between a PSTN number and subaddress, which is a telephone number in a PSTN numbering system, and a VoIP number, which is a telephone number in a VoIP numbering system; and
call-receiving control means which, if a call arrives at the VoIP interface, identifies a PSTN number and subaddress stored in the storage means corresponding to the VoIP number, which is the called party number of the call, converts the identified PSTN number and subaddress to the called party number of the call, and transmits the call through the PSTN interface.

5. A call relaying method in which a VoIP gateway apparatus relays a call between a PSTN interface and an IP telephone network interface, the method comprising the steps of:
if a call arrives at the PSTN interface, referring to storage means which stores a correspondence between a PSTN number, which is a telephone number in a PSTN numbering system, and a VoIP number, which is a telephone number in a VoIP numbering system, identifying the VoIP number corresponding to the PSTN number given to the calling party number of the call, converting the calling party number of the call to the identified VoIP number, and transmitting the call through the VoIP network interface; and
if a call arrives at the VoIP network interface, referring to the storage means, identifying the PSTN number corresponding to the VoIP number, which is the called party number of the call, converting the called party number of the call to the identified PSTN number, and transmitting the call through the PSTN network interface.
